(19) United States
(12) Patent Application Publication
(10) Pub. No.: US 2014/0246966 A1
(43) Pub. Date: Sep. 4, 2014

(54) COMPACT HOLDING CABINET

(71) Applicant: MANITOWOC FOODSERVICE COMPANIES, LLC, MANITOWOC, WI (US)

(72) Inventor: Roberto Nevarez, Hudson, FL (US)

(73) Assignee: MANITOWOC FOODSERVICE COMPANIES, LLC, MANITOWOC, WI (US)

(21) Appl. No.: 14/350,333

(22) PCT Filed: Oct. 17, 2012
(86) PCT No.: PCT/US2012/060670

§ 371 Date: Apr. 7, 2014

Related U.S. Application Data
(60) Provisional application No. 61/684,695, filed on Aug. 17, 2012.
(60) Provisional application No. 61/550,854, filed on Oct. 24, 2011.

(51) Int. Cl. A47J 39/00

(52) U.S. Cl. CPC A47J 39/006
USPC 312/236; 29/428; 312/283

(57) ABSTRACT

A food holding cabinet for holding food with a carrier that can be moved in and out of the cabinet be either a front door or a rear door. The food holding cabinet comprises an assembly with slots and fixtures that facilitate the motion of the carrier.

### CROSS-REFERENCED APPLICATIONS

This application is a national phase application of PCT/US12/60670, filed on Oct. 17, 2012, which claims priority to US Provisional Application Nos. 61/550,854, filed on Oct. 24, 2011, and 61/684,695, filed on Aug. 17, 2012, all of which are incorporated herein by reference in their entirety.

### BACKGROUND OF THE DISCLOSURE

1. Field of the Disclosure

This disclosure relates to a double-sided holding cabinet for food that is maintains a thermal environment for food when food is contained within the holding cabinet. In particular, the disclosure provides a carrier to slide on rails to extend from either a front or a rear of the holding cabinet.

2. Description of Related Art

Holding cabinets in the food service (e.g., fast food) industry are required to maintain the temperature of cooked food prior to serving. This is particularly so during times when large amounts of food must be pre-cooked in anticipation of numerous consumers, such as during lunch. Further, holding cabinets do not have trays, and in particular, half-sized trays, that are compatible with ovens.

Accordingly, there is a need for a holding cabinet for food that is able to be accessed from opposite sides, that permits simple transfer of the food from an oven to the holding cabinet and that is able to maintain the safety and consistency of the food that is being held in the holding cabinet.

### SUMMARY

The present disclosure provides for a holding cabinet comprising a carrier that supports a tray for carrying food and further comprising rails that permit an operator to lift and slide the carrier from opposite sides of the holding cabinet.

The present disclosure also provides for a holding cabinet having openings on opposite sides of such cabinet that are each covered by a door. When an operator pulls a carrier from the cabinet, a door is opened such that the door opens past a horizontal position during egress of the carrier.

The present disclosure further provides for a holding cabinet having a universally sized half-sized tray that is able to be used with a wide variety of holding cabinets and cooking devices. The universally sized half-sized tray permits direct transfer of food on such tray from a cooking device to a holding cabinet using the same tray.

The present disclosure still further provides for a holding cabinet having doors that automatically close to prevent the escape of moisture after ingress and egress of carrier from holding cabinet.

The present disclosure further provides for a holding cabinet having a carrier that holds a standard half-sized tray that is able to be transferred from a cooking device to the holding cabinet.

An embodiment of a food holding cabinet according to the present disclosure comprises a housing that comprises a front door and a rear door disposed in a front panel and a rear panel, respectively. A carrier is movable from a first position entirely within the housing to one of a second position and a third position outside of the front door and the rear door, respectively. The carrier carries one or more food carrying trays that are placed on and removed from the carrier when in the second position and the third position.

In another embodiment of a food holding cabinet according to the present disclosure, the carrier comprises a guide that pushes the front door open if being moved from the first position to the second position and pushes the rear door open if moving from the first position to the third position.

In another embodiment of a food holding cabinet according to the present disclosure, an assembly permits the carrier to move between the first position and the second third positions.

In another embodiment of a food holding cabinet according to the present disclosure, the assembly comprises a first rail and a second rail disposed on opposite sides of the carrier and first and second fixtures disposed on opposite sides of the housing in contact with the first and second rails, respectively.

In another embodiment of a food holding cabinet according to the present disclosure, each of the first and second rails comprises a longitudinal slot that mates with a corresponding one of the first and second fixtures to provide a sliding motion to the carrier.

In another embodiment of a food holding cabinet according to the present disclosure, the longitudinal slot is a first longitudinal slot. Each of the first and second rails comprises a second longitudinal slot that mates with a corresponding one of the first and second fixtures to provide a sliding motion to the carrier along the first and second longitudinal slots out of the front and rear doors, respectively.

In another embodiment of a food holding cabinet according to the present disclosure, the first and second fixtures each comprises a plurality of rollers disposed to mate with the first and second longitudinal slots of the first and second rails, respectively.

In another embodiment of a food holding cabinet according to the present disclosure, the assembly further facilitates removal of the carrier with the first and second rails from the housing.

In another embodiment of a food holding cabinet according to the present disclosure, the front and rear doors are operated by one of: mechanically by hand and digitally by a controller.

In another embodiment of a food holding cabinet according to the present disclosure, the cabinet further comprises a plurality of tiers, a first one of which comprises the housing and the carrier and a second one of which is identical to the first tier.

In another embodiment of a food holding cabinet according to the present disclosure, different ones of the tiers are shaped to hold pans of different shapes.

In another embodiment of a food holding cabinet according to the present disclosure, the housing further comprises a first metallic plate and a second metallic plate spaced from one another by a gap with the carrier disposed in the gap. A first heater and a second heater are disposed below and above the first and second metallic plate, respectively.

In another embodiment of a food holding cabinet according to the present disclosure, one of the first and second heaters is an infrared heater and the other of the first and second heaters is a conduction heater.

In another embodiment of a food holding cabinet according to the present disclosure, the carrier is optionally replaced by one or more trays or pans.

An embodiment of method for holding food in a cabinet according to the present disclosure comprises:

providing a housing that comprises a front door and a rear door disposed in a front panel and a rear panel, respectively;

moving a carrier from a first position entirely within the housing to one of a second position and a third position outside of the front door and the rear door, respectively; and

placing one or more food carrying trays on and removing food carrying trays from the carrier if in the second position and if in the third position.

In another embodiment of the method according to the present disclosure, the method further comprises:

if the carrier is being moved from the first position to the second position, pushing the front door open; and

if the carrier is moving from the first position to the third position, pushing the rear door open.

In another embodiment of the method according to the present disclosure, the method further comprises:

providing the carrier with rails and the housing with fixtures that cooperate with the rails to move the carrier with a sliding motion between the first position and at least one of the second and third positions.

In another embodiment of the method according to the present disclosure, the front and rear doors are operated by one of: mechanically by hand and digitally by a controller.

In another embodiment of the method according to the present disclosure, the method further comprises providing a plurality of tiers, a first one of which comprises the housing and the carrier and a second one of which is identical to the first tier.

In another embodiment of the method according to the present disclosure, different ones of the tiers are shaped to hold pans of different shapes.

### BRIEF DESCRIPTION OF THE DRAWINGS

Other and further benefits, advantages and features of the present disclosure will be understood by reference to the following specification in conjunction with the accompanying drawings, in which like reference characters denote like elements of structure.

FIG. 1 illustrates a perspective view of a closed compact holding cabinet according to the present disclosure;

FIG. 2 illustrates cross section view of holding cabinet with tray extending from the left of holding cabinet;

FIG. 3 illustrates a cross-section view of holding cabinet with tray extending from the right of holding cabinet;

FIG. 4 illustrates a perspective view of holding cabinet of FIG. 1 with carrier and tray extending from the holding cabinet;

FIG. 5 illustrates a further cross-section view of holding cabinet of FIG. 1;

FIG. 6 illustrates a perspective view of the rail of the holding cabinet of FIGS. 2 and 3;

FIG. 7 illustrates a perspective view of the compact holding cabinet of the present disclosure with the carrier entirely removed from the cabinet;

FIGS. 8-10 are perspective views of other embodiments of the holding cabinet for one tier, two tiers and three tiers with mechanical control according to the present disclosure;

FIGS. 11-13 are perspective views of further embodiments of the holding cabinet for one tier, two tiers and three tiers with digital control according to the present disclosure;

FIG. 14 is a perspective view of the holding cabinet of FIG. 10 with different types of pans according to the present disclosure;

FIG. 15 is an exploded perspective view of a tier of the holding cabinet of any of FIGS. 1-14 according to the present disclosure;

FIGS. 16 and 17 are exploded cross-sectional views of the tier of FIG. 15 according to the present disclosure;

FIG. 18 is a perspective view of a further embodiment of the three tier holding cabinet of FIG. 10 with a clear PC door according to the present disclosure; and

FIG. 19 is a perspective view of a further embodiment of the three tier holding cabinet of FIG. 10 with Cambro Pans according to the present disclosure.

### DESCRIPTION OF A PREFERRED EMBODIMENT OF THE DISCLOSURE

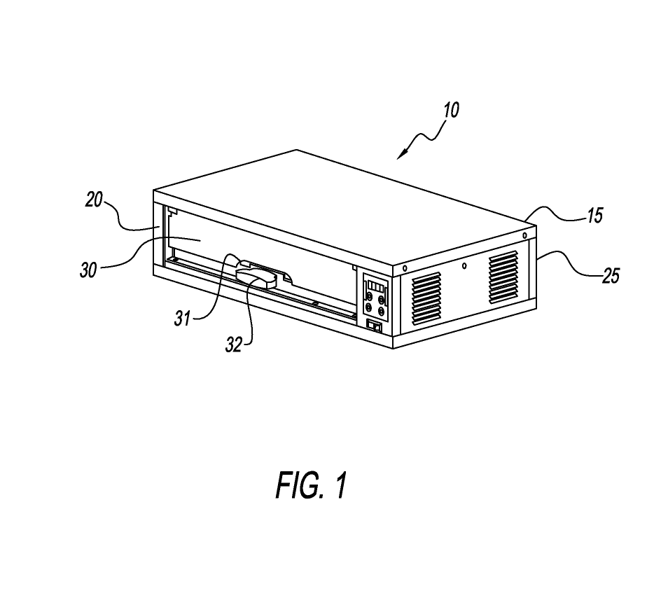

Referring to FIGS. 1-4, a holding cabinet of the present disclosure is shown and referenced generally by reference numeral 10. Holding cabinet 10 has a housing 15 having a front panel 20 and a rear panel 25. Front panel 20 has a front door 30 and rear panel 25 has a rear door 35. Housing 15 contains a carrier 40 that slides on rails 70 and 72 to permit an operator to slide carrier 40 through front door 30 or rear door 35, whichever is being used. Access to the interior of housing 15 from either front panel 20 or rear panel 25 provides much improved utility of cabinet 10 in congested industrial kitchens where space is limited.

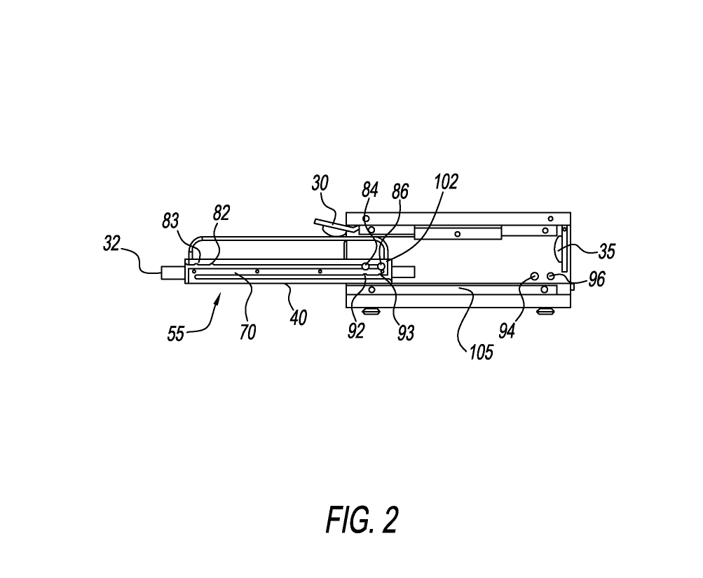

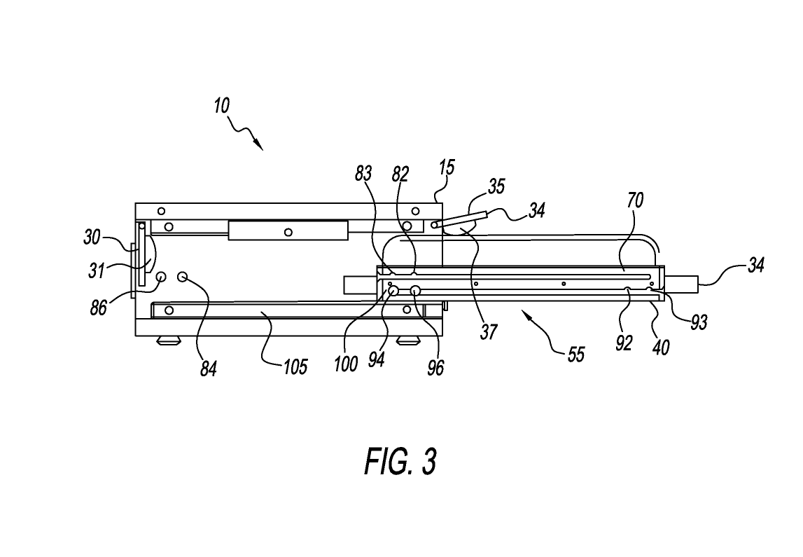

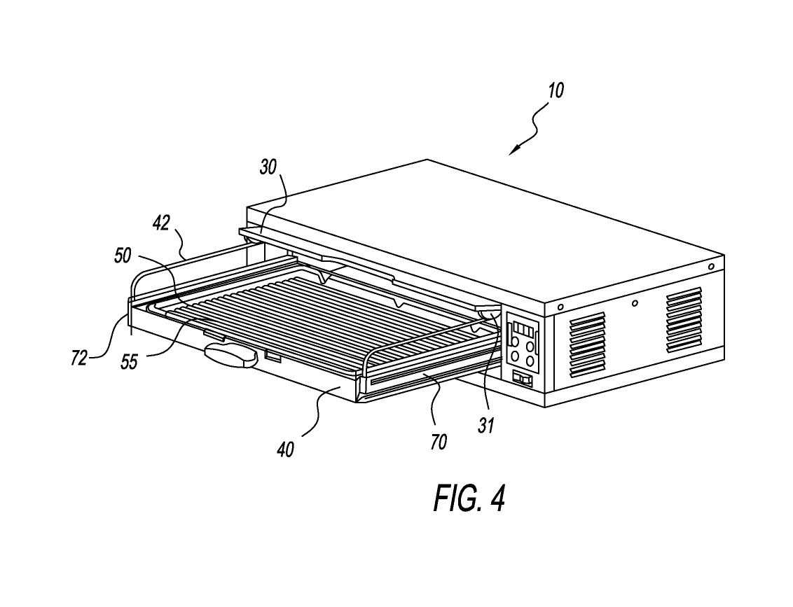

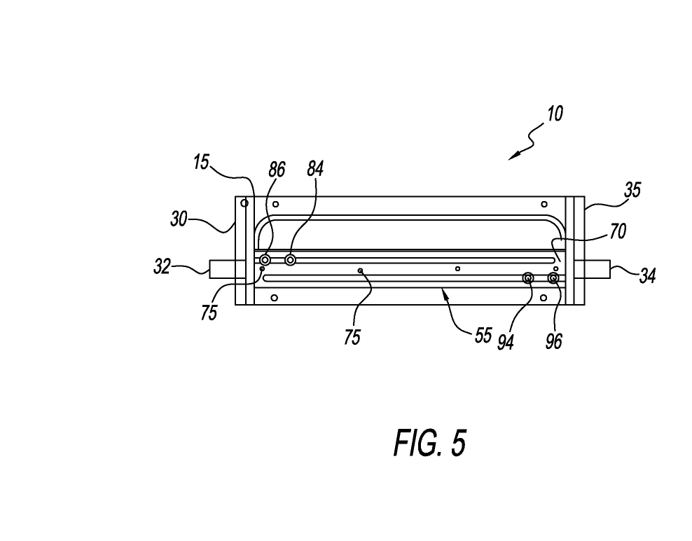

FIG. 2 shows cabinet 10 in which front door 30 is opened and carrier 40 is extended from housing 15. Similarly, FIG. 3 shows cabinet 10 in which rear door 35 is opened and through which carrier 40 is extended from housing 15. is Carrier 40 has a front pull 32 to enable an operator to pull carrier 40 from a first position inside of cabinet 10 out of front panel 20 to a second position outside of cabinet 10 to view or remove contents from a tray 50 (FIG. 4) supported by carrier 40, as shown in FIG. 2. Similarly, carrier 40 has a rear pull 34 to permit an operator to pull carrier 40 from rear panel 25, as shown in FIG. 3. When carrier 40 is at the first position inside housing 15, front pull 32 and rear pull 34 extend out of housing 15 via front and rear doors 30 and 35 as shown in FIGS. 1 and 5. For example, front pull 32 extends through an opening 31 (FIG. 1) of front door 30 and rear pull 34 extends through a similar opening (not shown) of rear door 35.

The contents of carrier 40 on tray 50 are easily accessed from both sides of cabinet 10 by pulling carrier 40 through front door 30 or rear door 35, as shown in FIG. 4. The double sided access to cabinet 10 via front and rear doors 30 and 35 provides much needed efficiency to the cooking environment in an industrial kitchen or fast food service environment.

Carrier 40 has an upper guide 42 that interfaces with front door 30 and rear door 35 to push front door 30 and rear door 35 into an opened configuration. Front door 30 and rear door 35 are hinged to housing 15. Front door 30 and rear door 35 close under their own weight when carrier 40 is completely inside of housing 15 to prevent moisture from escaping from the interior of cabinet 10. Further, front door 30 and rear door 35 each has a rounded portion 31 and 37, respectively. When guide 42 of carrier 40 contacts rounded portion 31 and 37 of doors 30, 35, respectively, such doors are opened past a horizontal position or past zero degrees to enable egress of tray 50 and carrier 40 from housing 15.

Tray 50 is removable from carrier 40 and is half sized. By being removable, tray 50 is easily cleaned. The half-sized tray is a common or standard sized tray in commercial kitchens for cooking and in holding cabinets to permit direct transport of cooked food from cooking device to holding cabinet 10. Tray 50 eliminates the additional step of transferring cooked food to a different surface from the one on which such food is originally cooked.

Referring to FIG. 4, tray 50 has a surface 55 on which food that is being held in holding cabinet 10 is placed. Further, surface 55 is preferably, a non-flat, and particularly a ridged surface or a surface having a plurality of tines. By not being flat, surface 55 ensures that moisture will not collect beneath cooked food, and specifically between cooked food and surface 55. Food that is cooked on a flat surface may not be as crispy due to trapped moisture. Surface 55 is also constructed of a metallic material. The metallic material of surface 55 ensures that repeated heating or extended exposure in a heated environment will not introduce impurities to cooked food.

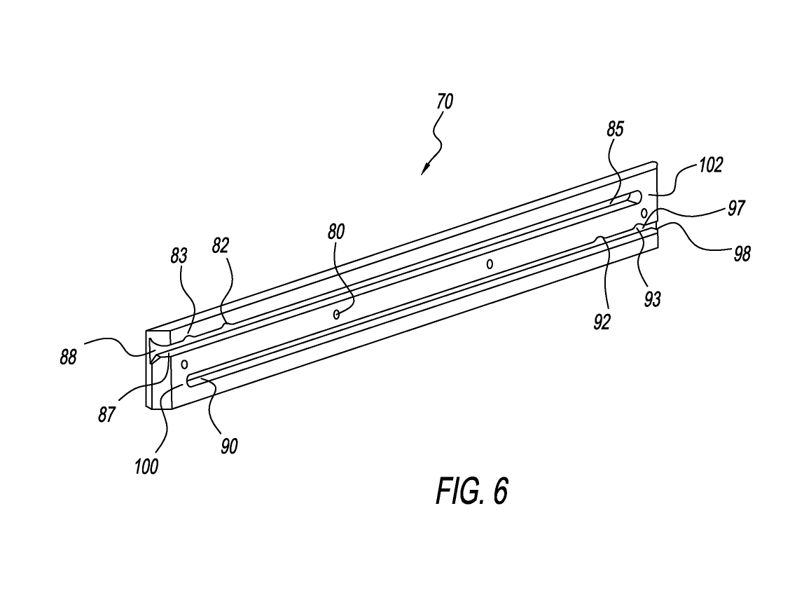

Referring to FIGS. 2, 3, 5 and 6, cabinet 10 further comprises an assembly 55 that comprises two rails, namely a rail 70 on one side of housing 15 and a rail 72 on an opposite side of housing 15. Rail 70 and rail 72 enable carrier 40 to slide in cabinet 10 during use. Only rail 70 will be discussed, although the function of rail 72 is identical. Rail 70 is affixed to carrier 40 by fasteners 75 at holes 80 (FIGS. 5 and 6). Rail 70 has a two-tiered rail system and contains an upper longitudinal slot 85 and a lower longitudinal slot 90. Upper longitudinal slot 85 has a first detent 82 and a second detent 83. Lower longitudinal slot 90 has a first detent 92 and a second detent 93. Upper longitudinal slot 85 has a narrow width region 87 and an expanded width region 88. Similarly, lower longitudinal slot 90 has a narrow width region 97 and an expanded width region 98.

Assembly 55 further comprises an upper roller 84, an upper roller 86, a lower roller 94 and a lower roller 96 affixed to a side of housing 15 adjacent rail 70. Assembly 55 also comprises similar rollers affixed to an opposite side of housing 15 adjacent rail 72. Upper longitudinal slot 85 has a sliding relationship with rollers 84 and 86 to permit relative movement between rollers 84, 86 and upper longitudinal slot 85. Lower longitudinal slot 90 has a sliding relationship with rollers 94 and 96 to permit relative movement between rollers 94, 96 and lower slot 90. Each roller 84, 86, 94 and 96 has a wide head and a narrow neck connected to the head. As shown in FIG. 5, when carrier 40 is entirely contained inside of housing 15, the neck of each roller 84, 86, 94 and 96 lies in detent 82, 83, 92 and 93 respectively.

In use, when an operator wishes to pull carrier 40 from housing 15 as shown in FIG. 2 (to the left in FIG. 2), carrier 40 is pulled via pull 32 with sufficient force to lift rail 70, and in particular, detents 92 and 93, over a neck of rollers 94 and 96. Rail 70 slides in housing 15 on rollers 84 and 86 of upper longitudinal slot 85. Rail 70 slides over rollers 84 and 86 until first roller 84 abuts stop 102 at back of upper longitudinal slot 85. Similarly, when an operator wishes to pull carrier 40 from housing 15 as shown in FIG. 3 to the right, carrier 40 is pulled via pull 34 with sufficient force to lift rail 70 and in particular, detents 82 and 83 over necks of rollers 86 and 84, respectively. Rail 70 slides in housing on rollers 94 and 96 of lower slot 90. Rail 70 slides over rollers 94 and 96 of lower longitudinal slot 90 until roller 94 abuts stop 100 at back of lower slot 90.

Carrier 40 is positioned a distance above a heater 105 and so as not rub against heater 105 and damage bottom of carrier 40.

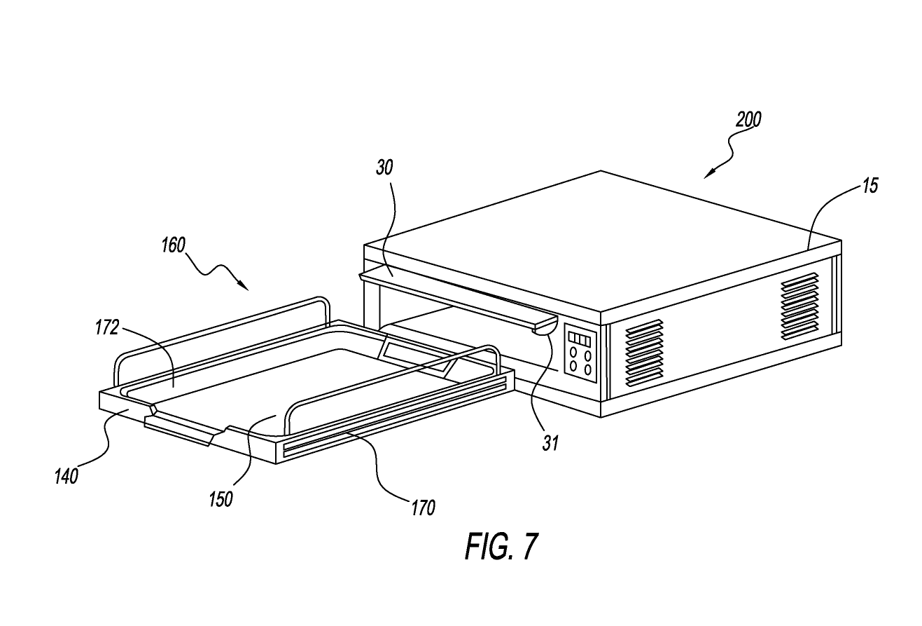

Referring to FIG. 7, in a further embodiment of the present disclosure, a holding cabinet 200 has numerous identical features as cabinet 10 that will be identically numbered. However, cabinet 200 has a unitary carrier 160 that is completely removable from housing 15. Unitary carrier 160 has three components, a carrier 140, rails 170 and 172 and a tray 150. By being completely removable from housing 15, unitary carrier 160 and in particular, carrier 140, rails 170 and 172 and a tray 150 can be easily and completely is cleaned. When a user wishes to clean unitary carrier 160, carrier 160 is pulled from housing 15 via rails 170 and 172 with a force to permit rails to move over detents or other similar feature that would provide resistance. Rails 170 and 172 do not contain stops 100 and 102, respectively. Detents keep unitary carrier 160 in housing 15 when a lesser force is used to move carrier in housing 15.

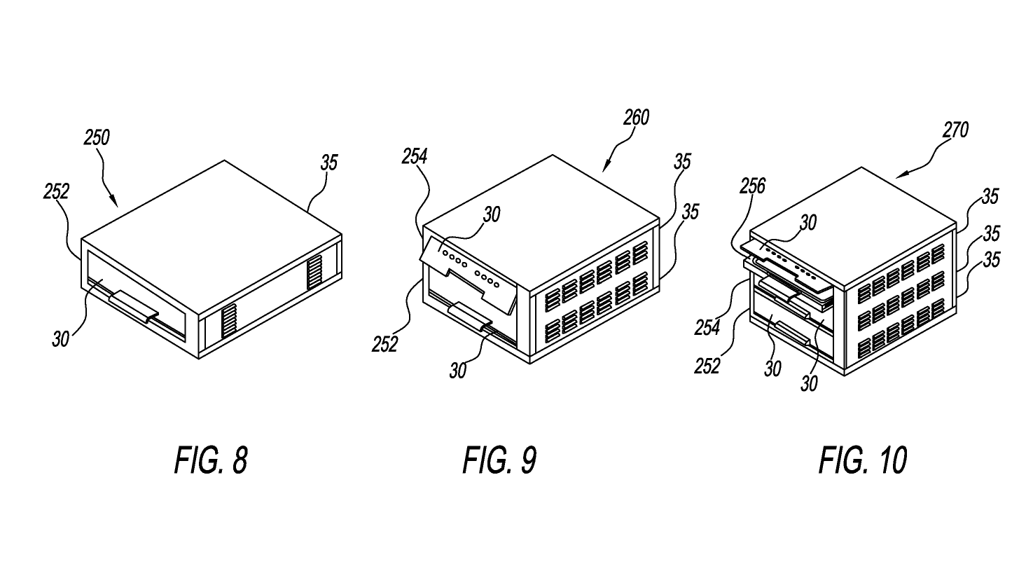

Referring to FIG. 8, in a further embodiment of the present disclosure, a holding cabinet 250 comprises a first tier 252 with front door 30 and rear door 35, each of which can be opened and closed mechanically by an operator.

Referring to FIG. 9, in a further embodiment of the present disclosure, a holding cabinet 260 comprises first tier 252 and a second tier 254, which also comprises a front door 30 and a rear door 35, each of which can be opened and closed mechanically by an operator.

Referring to FIG. 10, in a further embodiment of the present disclosure, a holding cabinet 270 comprises first tier 252, second tier 254 and a third tier 256, which also comprises a front door 30 and a rear door 35, each of which can be opened and closed mechanically by an operator.

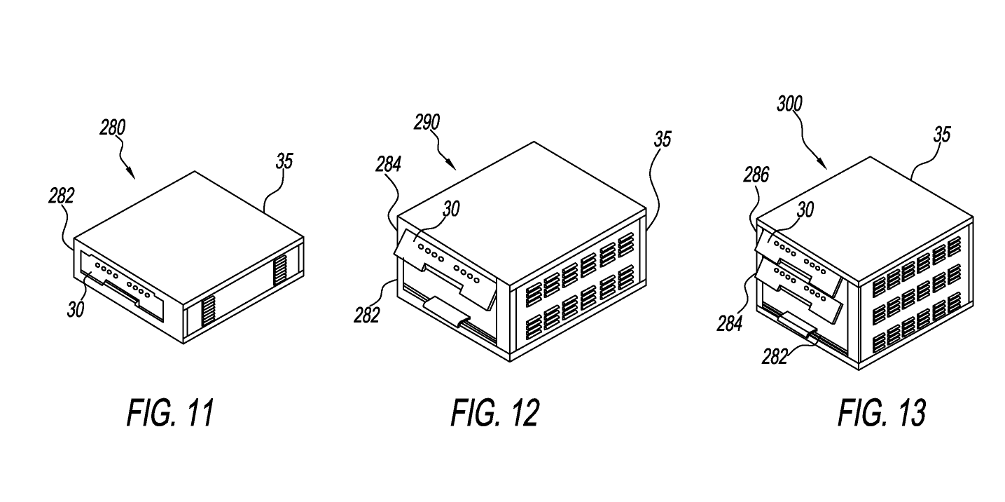

Referring to FIG. 11, in a further embodiment of the present disclosure, a holding cabinet 280 comprises a first tier 282 with front door 30 and rear door 35, each of which can be opened and closed digitally by a controller (not shown).

Referring to FIG. 12, in a further embodiment of the present disclosure, a holding cabinet 290 comprises first tier 282 and a second tier 284, which also comprises a front door 30 and a rear door 35, each of which can be opened and closed digitally by a controller (not shown).

Referring to FIG. 13, in a further embodiment of the present disclosure, a holding cabinet 300 comprises first tier 282, second tier 284 and a third tier 286, which also comprises a front door 30 and a rear door 35, each of which can be opened and closed digitally by a controller (not shown).

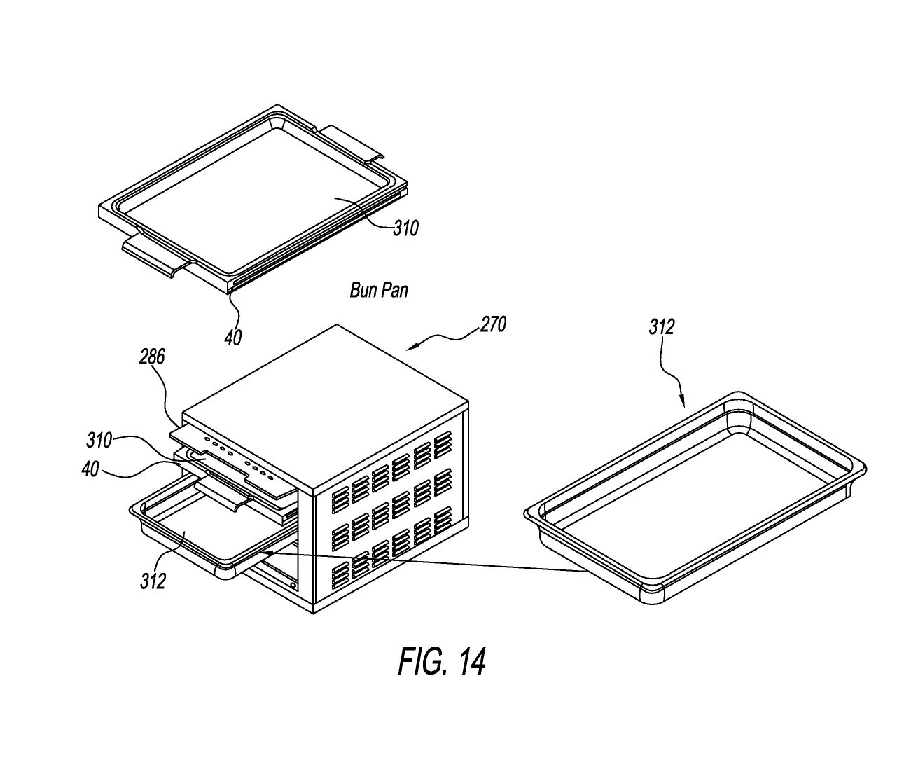

Referring to FIGS. 10 and 14, holding cabinet 270 is shown with a bun pan 310 disposed on carrier 40 of third tier 256 and a Cambro Pan 312 disposed in second tier 254.

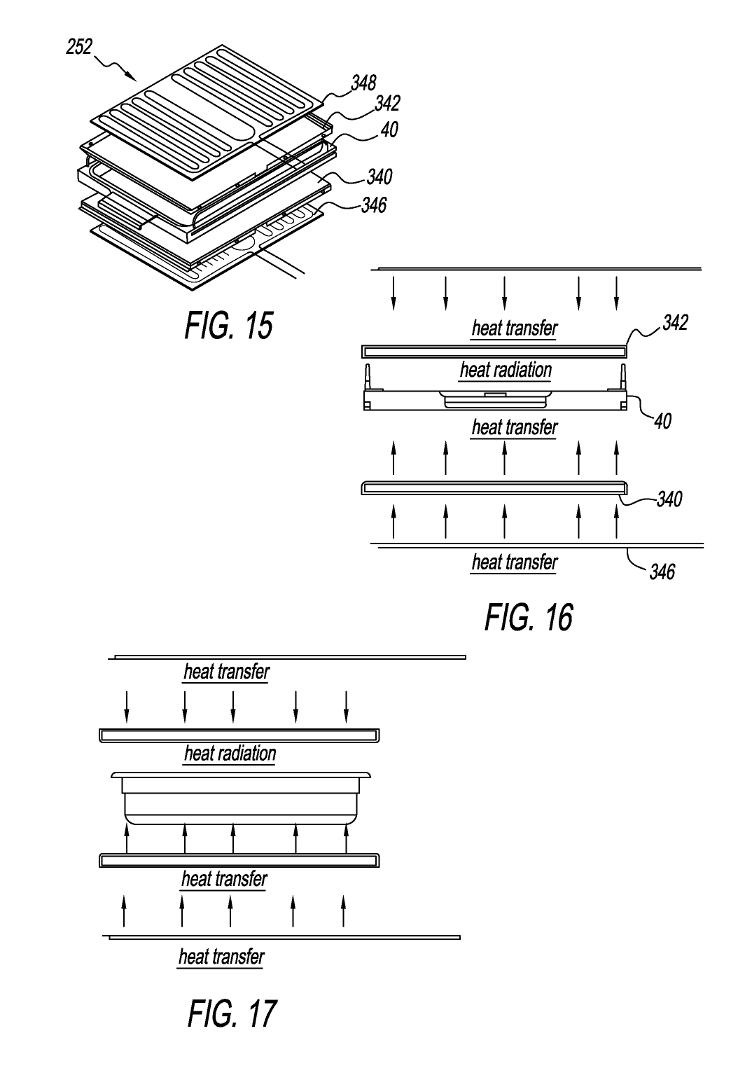

Referring to FIG. 15-17, a tier of any of the holding cabinets of FIGS. 1 and 8-12 is shown in an exploded perspective view. By way of example, the tier shown in FIGS. 15-17 will be described for first tier 252 of FIG. 8. Tier 252 comprises carrier 40 (FIGS. 15 and 16) disposed in a gap between a lower metallic plate 340 and an upper metallic plate 342. Metallic plates 340 and 342 are preferably aluminum or an aluminum alloy, but could be other suitable metals or alloys. In FIG. 17, carrier 40 is replaced by a Cambro pan.

A heater 346 is disposed below lower metallic plate 340 and a heater 348 is disposed above metallic plate 348. Preferably, each heater 346 and 348 is a foil heater adhered to metallic plates 340 and 342, respectively, on a side opposite to carrier 40. Thus, heater 346 is adhered to a bottom of metallic plate 340 and heater 348 is adhered to a top of metallic plate 342. For example, heaters 346 and 348 may be adhered to respective metallic plates 340 and 342 by gluing, pasting, epoxy and other suitable materials.

Preferably, heater 348 is an infrared heater so that heat transfer from metallic plate 342 to the top of carrier 40 is by heat radiation. Preferably, heater 342 is a conduction heater so that heat transfer from metallic plate 340 to the bottom of carrier 40 is by heat conduction. However, other types of heaters may be used.

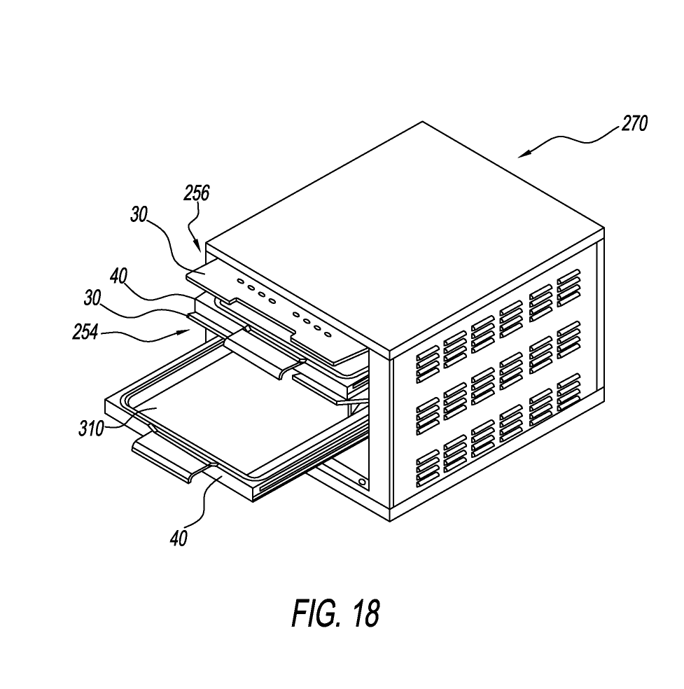

Referring to FIGS. 10 and 18, holding cabinet 270 is shown with a standard bun pan 310 on carrier 40 of second tier 254. Doors 30 of second tier 254 and third tier 256 are preferably clear PC doors to keep moisture.

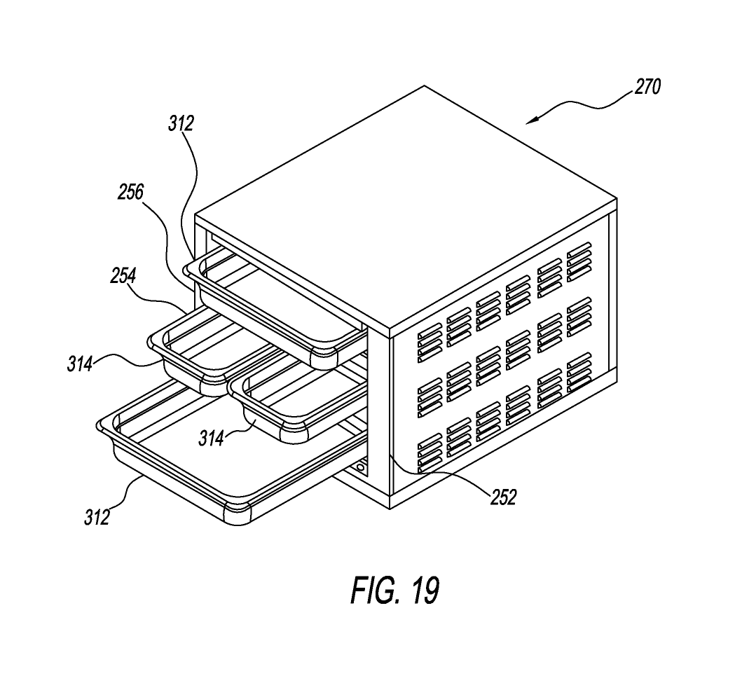

Referring to FIGS. 10 and 19, holding cabinet 270 is shown with deeper pans that replace carriers 40 (FIG. 10) of tiers 252, 254 and 256. By way of example, pans 312 are disposed in first and third tiers 252 and 156. A pair of narrower pans 314 is placed side by side in second tier 254.

The present disclosure has been described with particular reference to the preferred embodiments. It should be understood that the foregoing descriptions and examples are only illustrative of the present disclosure. Various alternatives and modifications thereof can be devised by those skilled in the art without departing from the scope of the present disclosure. Accordingly, the present disclosure is intended to embrace all such alternatives, modifications, and variations that fall within the scope of the disclosure.

What is claimed is:

1. A food holding cabinet comprising:
a housing that comprises a front door and a rear door disposed in a front panel and a rear panel, respectively; and
a carrier that is movable from a first position entirely within said housing to one of a second position and a third position outside of said front door and said rear door, respectively, and that carries one or more food carrying trays, that are placed on and removed from said carrier when in said second position and said third position.

2. The food holding cabinet of claim 1, wherein said carrier comprises a guide that pushes said front door open if being moved from said first position to said second position and pushes said rear door open if moving from said first position to said third position.

3. The food holding cabinet of claim 1, further comprising an assembly that permits said carrier to move between said first position and said second third positions.

4. The food holding cabinet of claim 3, wherein said assembly comprises a first rail and a second rail disposed on opposite sides of said carrier and first and second fixtures disposed on opposite sides of said housing in contact with said first and second rails, respectively.

5. The food holding cabinet of claim 4, wherein each of said first and second rails comprises a longitudinal slot that mates with a corresponding one of said first and second fixtures to provide a sliding motion to said carrier.

6. The food holding cabinet of claim 5, wherein said longitudinal slot is a first longitudinal slot, wherein each of said first and second rails comprises a second longitudinal slot that mates with a corresponding one of said first and second fixtures to provide a sliding motion to said carrier along said first and second longitudinal slots out of said front and rear doors, respectively.

7. The food holding cabinet of claim 6, wherein said first and second fixtures each comprises a plurality of rollers disposed to mate with said first and second longitudinal slots of said first and second rails, respectively.

8. The food holding cabinet of claim 4, wherein said assembly further facilitates removal of said carrier with said first and second rails from said housing.

9. The food holding cabinet of claim 1, wherein said front and rear doors are operated by one of: mechanically by hand and digitally by a controller.

10. The food holding cabinet of claim 1, further comprising a plurality of tiers, a first one of which comprises said housing and said carrier and a second one of which is identical to said first tier.

11. The food holding cabinet of claim 10, wherein different ones of said tiers are shaped to hold pans of different shapes.

12. The food holding cabinet of claim 1, wherein said housing further comprises:
a first metallic plate and a second metallic plate spaced from one another by a gap with said carrier disposed in said gap; and
a first heater and a second heater disposed below and above said first and second metallic plate, respectively.

13. The food holding cabinet of claim 12, wherein one of said first and second heaters is an infrared heater and the other of said first and second heaters is a conduction heater.

14. The food holding cabinet of claim 12, wherein said carrier is optionally replaced by one or more trays or pans.

15. A method for holding food in a cabinet comprising:
providing a housing that comprises a front door and a rear door disposed in a front panel and a rear panel, respectively;
moving a carrier from a first position entirely within said housing to one of a second position and a third position outside of said front door and said rear door, respectively; and
placing one or more food carrying trays on and removing food carrying trays from said carrier if in said second position and if in said third position.

16. The method of claim 15, further comprising:
if said carrier is being moved from said first position to said second position, pushing said front door open; and
if said carrier is moving from said first position to said third position, pushing said rear door open.

17. The method of claim 16, further comprising:
providing said carrier with rails and said housing with fixtures that cooperate with said rails to move said carrier with a sliding motion between said first position and at least one of said second and third positions.

18. The method of claim 16, wherein said front and rear doors are operated by one of: mechanically by hand and digitally by a controller.

19. The method of claim 16, further comprising providing a plurality of tiers, a first one of which comprises said housing and said carrier and a second one of which is identical to said first tier.

20. The method of claim 19, wherein different ones of said tiers are shaped to hold pans of different shapes.
